(19) United States
(12) Patent Application Publication
(10) Pub. No.: US 2022/0217120 A1
(43) Pub. Date: Jul. 7, 2022

(54) MINIMIZATION OPTIMIZATIONS FOR WEB APPLICATION FIREWALLS

(71) Applicant: Fastly Inc., San Francisco, CA (US)

(72) Inventors: Katherine Flavel, San Francisco, CA (US); Scott Vokes, San Francisco, CA (US)

(21) Appl. No.: 17/210,289

(22) Filed: Mar. 23, 2021

Related U.S. Application Data
(60) Provisional application No. 63/133,525, filed on Jan. 4, 2021.
(60) Provisional application No. 63/155,445, filed on Mar. 2, 2021.

(51) Int. Cl. H04L 29/06; G06F 16/901

(52) U.S. Cl. CPC H04L 63/0245; H04L 63/1441; G06F 16/9024

(57) ABSTRACT

Technology is disclosed herein for optimizing the process of minimization a graph so as to produce a minimized version of the graph for a web application firewall in less time than otherwise and consuming fewer resources. In particular, multiple optimizations are disclosed herein that include: a first optimization that groups states based on their distance to a final state; a second optimization that removes equivalence classes that have less than two states; a third optimization that splits equivalence classes while in-place; and a fourth optimization that splits equivalence classes using the label set that occurs in a given class. The minimization optimizations may be implemented individually or in combination with one another.

### RELATED APPLICATIONS

This application is related to, and claims the benefit of priority to, U.S. Provisional Patent Application No. 63/133,525, entitled “MINIMIZATION OPTIMIZATIONS FOR WEB APPLICATION FIREWALLS,” and filed on Jan. 4, 2021, as well as to U.S. Provisional Patent Application No. 63/155,445, also entitled “MINIMIZATION OPTIMIZATIONS FOR WEB APPLICATION FIREWALLS,” and filed on Mar. 2, 2021, both of which are hereby incorporated by reference in their entirety.

### TECHNICAL FIELD

Aspects of the disclosure are related to the field of Internet infrastructure services and, more particularly, to graph minimization optimizations for firewalls.

### BACKGROUND

Content delivery networks, edge cloud platforms, and other types of Internet infrastructure services send and receive huge volumes of data to and from servers and end points. Firewalls are typically employed to monitor the incoming and outgoing traffic based on predetermined rules to protect not only the servers, but also the customers, end users, and other entities affiliated with a given service.

A web application firewall (WAF) is a specific type of firewall that filters, monitors, and blocks traffic flowing to and from a web site or application. Customized inspection rules allow a web application firewall to prevent malicious attacks that seek to exploit security flaws that traditional network firewalls or other intrusion detection systems cannot prevent. The rules include regular expressions that define data patterns considered to be malicious and that therefore should be blocked.

Firewall rules can be implemented in a graph that includes nodes and edges representative of the states and transitions defined by the rules. For example, the rules may define the string fee as malicious, while leaving other strings unblocked implicitly—if not explicitly. An incoming string of characters with f-e-e contained therein would traverse the graph to an accepting state and would be blocked, whereas a string with f-o-o contained therein would not transition to an accepting state and would therefore be allowed to pass.

As a graph is updated with new rules, it undergoes a minimization process to eliminate equivalent states before being deployed, so as to increase its efficiency. The process of minimization can itself be very time consuming and resource intensive, but any delay in rolling out the updated rules can be even more costly from a security perspective. A balance is therefore sought between reaching the theoretical best minimization of a graph that takes a long time to produce, versus a minimization that is fast but produces a sub-optimal graph.

### Overview

Technology is disclosed herein for optimizing the process of minimizing a graph so as to produce a minimized version of the graph for a web application firewall in less time than otherwise and consuming fewer resources. In particular, multiple optimizations are disclosed herein that include: a first optimization that groups states based on their distance to a final state; a second optimization that removes equivalence classes that have less than two states; a third optimization that splits equivalence classes while in-place; and a fourth optimization that splits equivalence classes using the label set that occurs in a given class. The minimization optimizations may be implemented individually or in combination with one another.

In various implementations, an operating environment in which an optimized minimization process is employed includes one or more computers and their respective hardware, software, and/or firmware components. The minimization process directs the one or more computers to identify regular expressions indicative of data patterns to enforce against malicious traffic in a firewall. The computer(s) then generate(s) a graph based at least in part on the regular expressions, wherein the graph comprises states, labels, and transitions between certain ones of the states on certain ones of the labels. The computer(s) perform(s) a minimization of the graph to produce a minimized graph, including by grouping the states into equivalence classes based on a distance of each state to an accepting state. The minimized graph may then be employed in a web application firewall to protect against instances of the data patterns in data traffic flowing through the firewall.

In the same or other implementations, performing the minimization of the graph to produce the minimized graph includes determining whether a given equivalence class has less than two states. The computing system(s) determine(s) to attempt to split the given equivalence class when the given equivalence class has more than two states and determine(s) to refrain from attempting to split the equivalence class when the equivalence class has less than two.

In the same or other implementations, performing the minimization of the graph to produce the minimized graph further comprises attempting to split the given equivalence class into multiple equivalence classes by at least, for each label of the set of labels: evaluating a subset of the states in the given equivalence class to identify qualifying states that behave the same as each other on the label and differently relative to all others, splitting out the qualifying states into at least one new equivalence class; and continuing to evaluate the others of the subset of the states on remaining ones of the set of labels after splitting out the qualifying states on the label.

In the same or other implementations, performing the minimization of the graph to produce the minimized graph includes attempting to split the given equivalence class into multiple equivalence classes by at least: identifying a subset of the labels on which a subset of the states in the given equivalence class transition, wherein the subset of the labels comprises only those of the labels on which those of the states in the given equivalence class transition; for each label of only the subset of the labels, evaluating the subset of the states in the given equivalence class to identify qualifying states that behave the same as each other on the label and differently relative to all others on the label; and splitting out the qualifying states into at least one new equivalence class.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operational environment and a related operational scenario in an implementation of graph minimization optimizations.

FIG. 2 illustrates a minimization process in an implementation.

FIG. 3 illustrates a graph and state table in an implementation.

FIG. 4 illustrates an application of a non-optimized minimization process with respect to the graph in FIG. 3.

FIG. 5 illustrates a minimized version of the graph in FIG. 3.

FIG. 6 illustrates an application an optimized minimization process with respect to the graph in FIG. 3.

FIG. 7 illustrates a computing system suitable for implementing the various operational environments, architectures, processes, scenarios, and sequences discussed below with respect to the Figures.

### DETAILED DESCRIPTION

Web application firewalls generally employ pattern matching concepts whereby input sequences are compared to known patterns that represent malicious traffic that should be blocked or otherwise defended against. Such concepts can be implemented using graphs, which are fast mechanisms for scanning traffic in a firewall one symbol at a time. An input sequence either traverses a graph to an endpoint that blocks the sequence, or it traverses the graph to an endpoint that allows the sequence to pass through the firewall.

A graph can be visualized and understood as a set of points (sometimes referred to as vertices or nodes) and a set of lines (sometimes called edges) connecting the points. A graph used to implement firewall rules is an example of a directed graph, whereby the nodes of the graph represent the different states that the firewall can achieve, while the edges represent the transitions between states on different input symbols. A directed graph that has its edges labeled as such and where each edge is unique is an example of a deterministic finite automaton (DFA).

The function of a deterministic finite automaton in theory is to scan an input sequence one symbol at a time and decide whether to “accept” the sequence. This happens when a DFA transitions to an accepting (or final) state on a given input symbol. As applied to firewalls, an accepting state may correspond to a blocking action, for example. An input sequence that matches a known malicious string will eventually traverse the states of the DFA to an accepting state that determines to block the string.

The nodes of a DFA represent its various states, while the labeled edges of the DFA represent the transitions that happen from one state to the next on a given input symbol. In other words, a DFA is a state machine that attempts to find malicious strings in an input sequence which is useful in pattern matching and compilers, among other applications. In a firewall example, traffic that includes a malicious string causes the state machine to transition to an accepting state that blocks the offending traffic.

The labels of a DFA comprise its alphabet which can be small or large, depending upon the application. Each state in a DFA is defined by a transition function that describes how the state behaves with respect to the labels in the alphabet. In the case of a firewall, the alphabet is a set of characters that may pass through the firewall, potentially amounting to hundreds of labels. The rules of the firewall determine how its states transition on certain labels as they are encountered in an input sequence.

Consider for illustrative purposes two firewall rules: one that blocks packets that include the string fee, and another that blocks packets that include the string fie. A theoretical DFA that represents these rules includes six states: s0, s1, s2, s3, s4, and s5, with s0 being the start state. The DFA has: an alphabet comprised off, e, and i; and accepting states s3 and s5 that block any packets that include the strings fee and fie in their character sequences.

Upon starting, s0 transitions to s1 upon encountering fin an input string. S1 transitions to s2 upon encountering e after f in the sequence, but transitions to s4 upon encountering i in the sequence after f. S2 transitions to s3 upon encountering another e in the sequence after e, and s3 is an accepting state that blocks the packet. Similarly, s4 transitions to s5 upon encountering an e after i in the sequence and s5 blocks the packet. The following is a diagram of the exemplary DFA.

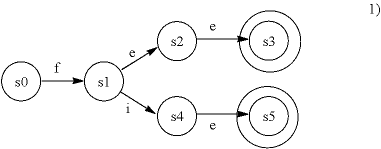

By simple observation it is apparent that states s2 and s4 share the same behavior. Likewise, states s3 and s5 share the same behavior. The DFA can thus be “minimized” to reduce the number of states by eliminating those that are redundant or pointless. When the DFA is compiled into a graph, code, or some other practical instantiation of the DFA, the minimized version of the DFA will produce a more efficient output than had it not been minimized. The following is a diagram of the exemplary DFA in its minimized form.

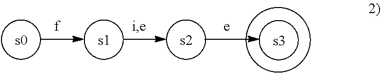

While the minimization process is trivial for such a simple DFA—and indeed, can be done manually—a number of algorithms exist for minimizing DFAs such as Moore's (1956) and Hoperoft's (1971) regardless of their simplicity or complexity. Briefly, Moore's algorithm starts with two equivalence classes (ECs) split into those that are ends and those that are not ends. It then proceeds to compare equivalence classes and progressively refines them for each edge label. Hoperoft's algorithm uses a “work queue” of splitters that checks each pair of ECs and labels, enqueuing the splitter for only the smaller EC upon being split.

Minimization is needed to reduce redundancy in a DFA, but the process of minimization can itself be very time consuming and resource intensive. In the context of web application firewalls, the time delay involved with minimization is a risk in and of itself, as the longer it takes to deploy new patterns to defend against malicious code, the longer a given website, application, or other such property is vulnerable to attack.

The technology disclosed herein includes multiple optimizations to the minimization of DFAs implemented in graphs that, independently or in combination with one or more of each other, serve to reduce the time and effort needed to minimize a graph, while producing acceptable results in view of the practical constraints of the environment. Various implementations of the optimizations are discussed below in the context of infrastructure services and web application firewalls, although the concepts apply as well to other contexts.

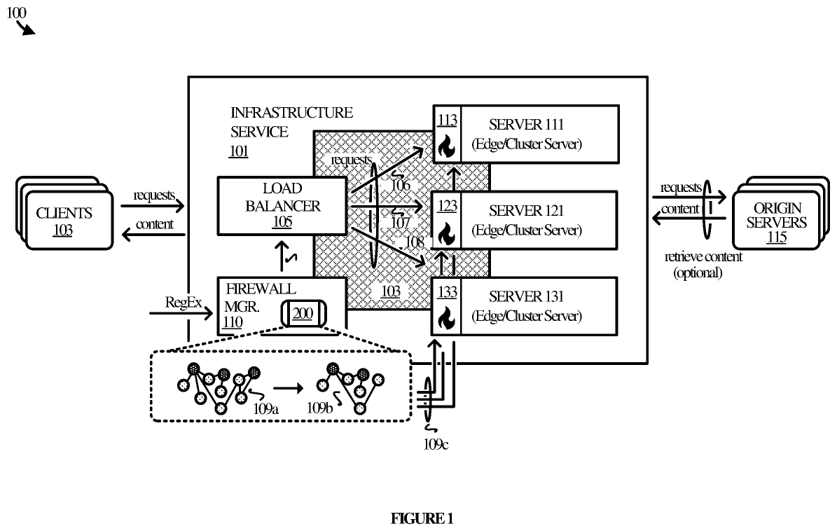

Referring now to the drawings, FIG. 1 illustrates operational environment 100 in an implementation of the minimization optimizations disclosed herein. Operational environment 100 includes infrastructure service 101, clients 103, and origin servers 115. Infrastructure service 101 is representative of a content delivery network, an edge cloud platform, or the like, and is comprised of various physical and/or virtual computing and communication elements suitable for implementing a variety of associated services (e.g., a web application).

Infrastructure service 101 includes load balancer 105, server 111, server 121, and server 131, all of which reside in infrastructure service 101 and exchange data over communication network 107. Other equipment may be included in infrastructure service 101 but are omitted for the sake of clarity. The elements of infrastructure service 101 may be co-located in a single Point-of-Presence (e.g., datacenter) or distributed over multiple PoPs. Infrastructure service 101 also includes firewall manager 110 which may reside locally or remotely with respect to the elements of infrastructure service 101.

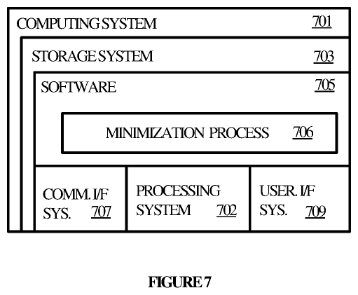

Load balancer 105 is representative of any physical or virtual computing equipment capable of distributing incoming packet traffic across various servers. Load balancer 105 may be implemented on one or more computing systems, of which computing system 701 in FIG. 7 is representative. Load balancer 105 may employ, for example, a hash algorithm, a round-robin algorithm, a random (or pseudo random) algorithm, or any other type of algorithm, combination, or variation thereof, to distribute traffic to server 111, server 121, and server 131. Load balancer 105 may be stateless (in that it does not track connections between end users and servers) or stateful (in that does track connections between end users and servers).

Datacenter fabric 103 is representative of any connections, networks, and/or collection of networks (physical or virtual) over which load balancer 105 may communicate with servers 111, 121, and 131. Datacenter fabric 107 may include various elements, such as switches, routers, and cabling to connect the various elements of infrastructure service 101. The elements may communicate with each other in accordance with any suitable protocol such as Ethernet, Fibre Channel, or InfiniB and, or any combination or variation thereof.

Server 111, server 121, and server 131 are each representative of any physical or virtual server computer suitable for processing incoming requests for content from clients 103 and serving content to clients 103, of which computing system 701 is also broadly representative. Clients 103 are representative of the various computing devices from which requests may originate and to which content may be served, such as consumer devices, enterprise devices, and the like. Examples include, but are not limited to, laptop and desktop computers, tablets, mobile phones, wearable devices, entertainment devices, gaming devices, other server computers, Internet of Things (IoT) devices, or any other type of end user computing device. Clients 103 communicate with infrastructure service 101 over one or more public or private networks (e.g., the Internet), combination of networks, or variations thereof.

Origin servers 115, which are optional, represent the source of content that may be cached by infrastructure service 101 in specific implementations. Origin servers 115 may be implemented on any physical or virtual computing system, of which computing system 701 in FIG. 7 is broadly representative. Examples of content that may be cached include text, images, video, web sites, objects, applications, or any other type of data, variation, or combination thereof. Origin servers 115 also communicate with infrastructure service 101 via one or more public or private networks, combination of networks, or variations thereof.

Firewall manager 110 is representative of any physical or virtual computing system having hardware, software, and/or firmware capable of determining and deploying firewall parameters to the elements of infrastructure service 101, examples of which include computing system 701 illustrated in FIG. 7. The parameters are deployed to instances of a web application firewall in each server represented by WAF 113, WAF 123, and WAF 133.

In operation, clients 103 send requests for content to infrastructure service 101. The requests reach load balancer 105 which, in turn, distributes them to servers 111, 121, and 131. For example: request 106 is sent to server 111; request 107 is sent to server 121; and request 108 is sent to server 131.

The servers 111, 121, and 131 are part of a group of servers that cache content sourced from origin servers 115. Responsibility for a given object may reside with any one or more of the servers in a PoP. When a given server receives a request for an object, that server is considered the “edge” server. The edge server first processes the request through its WAF and, if not blocked, then determines whether it has the object in its memory. If so, the server serves the object to the client. However, if the server does not have the object in its memory, it determines which “cluster” server in the datacenter is responsible for the object and forwards the request to that cluster server. If a responsible server does not have the object in its memory, then the server retrieves the content from an origin server. (The same or a different WAF in the edge server may also inspect traffic returning from the origin in some implementations.) The object is ultimately sent to the client either by the edge server directly, by the cluster server directly or indirectly, or by a combination of the two directly and/or indirectly.

The WAFs 113, 123, and 133 in servers 111, 121, and 131 respectively employ a graph to filter out malicious traffic. The graph, being a DFA, is maintained by firewall manager 110 which, as new definitions are discovered and added to the graph, provides updates to the WAFs. Firewall manager 110 updates a non-minimized version 109a of the graph based on regular expressions fed to it that represent malicious data patterns. Firewall manager 110 then produces a minimized version 109b of the graph and provides updates 109c to servers 111, 121, and 131 to be enforced by WAFs 113, 123, and 133 respectively. The WAFs consume input strings through the minimized version(s) of the graph to detect and block malicious data patterns in traffic flowing through the servers.

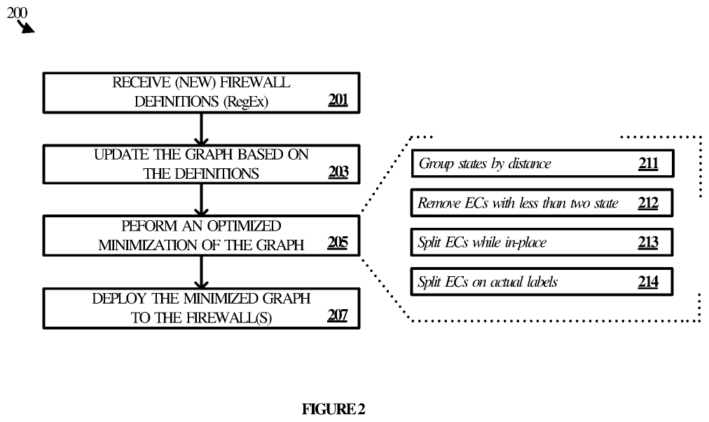

Firewall manager 110 employs a minimization process 200 to develop the WAF updates, the details of which are illustrated in FIG. 2. Minimization process 200 may be implemented in program instructions in the context of any of the software applications, modules, components, or other such programming elements of firewall manager 110. The program instructions direct its underlying physical or virtual computing system or systems to operate as follows, referring parenthetically to the steps in FIG. 2.

In operation, firewall manager 110 receives new firewall definitions with which to develop and/or update existing firewall parameters (step 201). The firewall definitions include regular expressions descriptive of malicious data patterns to be blocked. Firewall manager 110 updates a graph with the definitions so that the graph can be deployed to filter traffic flowing through the firewall (step 203). However, before deploying the graph, firewall manager 110 performs a minimization on the graph to reduce its size and complexity (step 205).

The minimization performed in step 205 includes one or more of optimizations 211-214. Optimization 211 entails grouping states into equivalence classes based on their distances to final (accepting) states. Where Moore's or Hoperoft's algorithm typically starts with two ECs (equivalence classes), one for final states and one for non-final states, these states can be further partitioned into groups with equal shortest distances to an end state (zero for the end states themselves). This eliminates the worst-case scenario which makes a deeply nested path to an end state require several passes. For example, consider an EC with one-thousand states where only the last state reaches the end state and is distinguishable. Using an initial partitioning based on the shortest distance puts the states with each distance into their own ECs, replacing quadratic repetition. This initial pass can be done in linear time. Optimization 211 can be used as a first pass, and then followed by any suitable algorithm (e.g., Moore's).

Optimization 212 relates to removing equivalence classes that have less than two states from further splitting attempts. It is axiomatic that ECs that have less than two elements cannot be partitioned further. However, minimization algorithms do not recognize this fact and as such waste cycles on checking whether such ECs can be split. Optimization 212 proposes that, if partitioning an EC creates a new EC with less than two elements, then the new EC is considered done, in that it will be not be analyzed for further splitting. Skipping ECs that have less than two states improves performance significantly, with far less complexity or overhead compared to the splitter queue management in Hoperoft's algorithm, which becomes more expensive as label counts increase.

Optimization 213 splits one or more new ECs off the existing EC but keeps processing the existing EC in-place, rather than creating two new ECs and attempting to split them right away on all labels. The newly created ECs are processed once the existing EC has been evaluated with respect to all of the labels. Processing the existing EC in-place means that the optimization continues to evaluate the states in the EC at the same or the next label where it split. This saves cycles since it avoids redundantly checking the remaining states in the existing EC for the labels that were just checked before splitting the EC. Checking those label again at that time is unlikely to uncover any new information, so it saves time to postpone further processing until the next pass through the data set, when information about their states' destination ECs is likely to be partitioned more finely.

Optimization 214 proposes to check what labels are actually in a given equivalence class and then attempts to split the class using just those labels, rather than trying all labels. In some scenarios, this optimization is used once the number of states falls below a certain threshold. The optimization employs an iterator to try partitioning on either: every label appearing throughout the entire DFA; or every label appearing within a specific EC. While attempting to partition an EC, the optimization counts the number of states split into the new ECs. If either EC has less than a threshold number of states, a flag is set in some scenarios indicating that the iterator should collect the labels that actually appear in the EC and check only those labels. This significantly reduces the overhead of checking for possible partitions in a large DFA label set when the EC's states only have a small number of edges.

Once the graph has been minimized using one or more of the optimizations, firewall manager 110 deploys the graph in its minimized state to one or more of the firewalls (step 207). Other steps in addition to those disclosed herein may also be performed where applicable, such as compiling the graph into code, into a table, a matrix, or the like. Firewall manager 110 deploys the updated graph by, for example, distributing a data file to each server that holds the data that comprises the graph (and optionally to load balancer 105). The updated (and minimized) graph may be distributed to the servers via a management plane within infrastructure service 101 or by any other suitable mechanism.

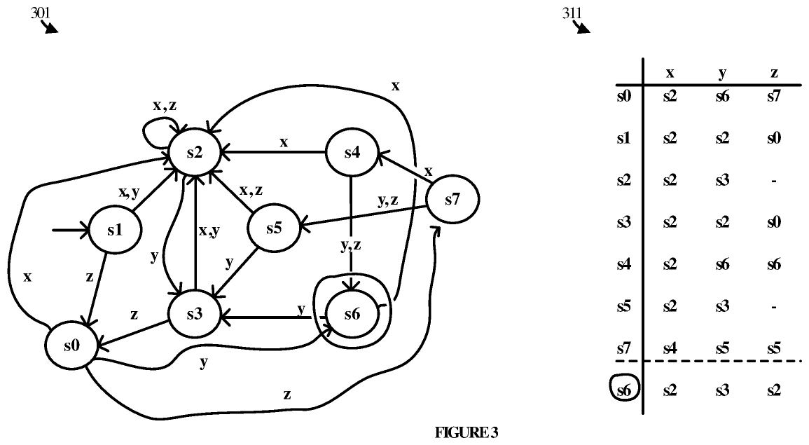

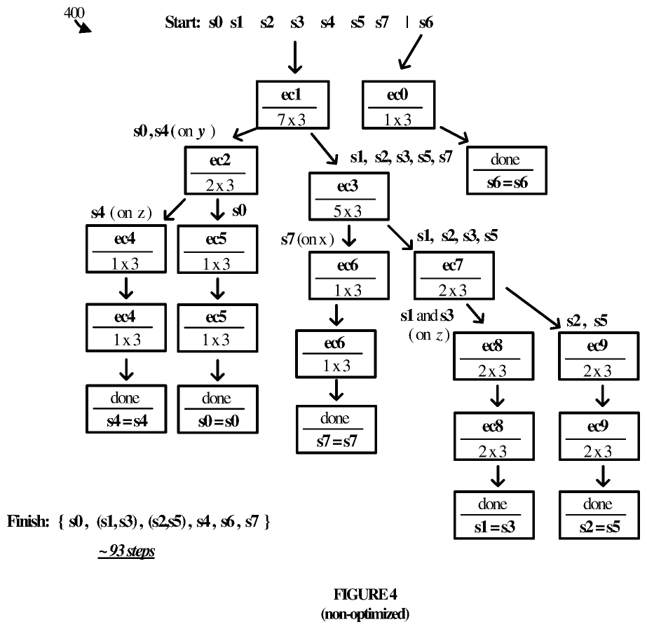

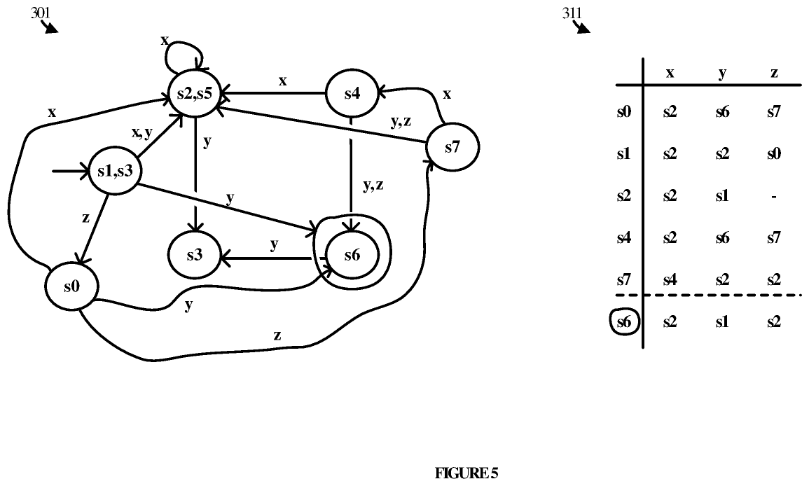

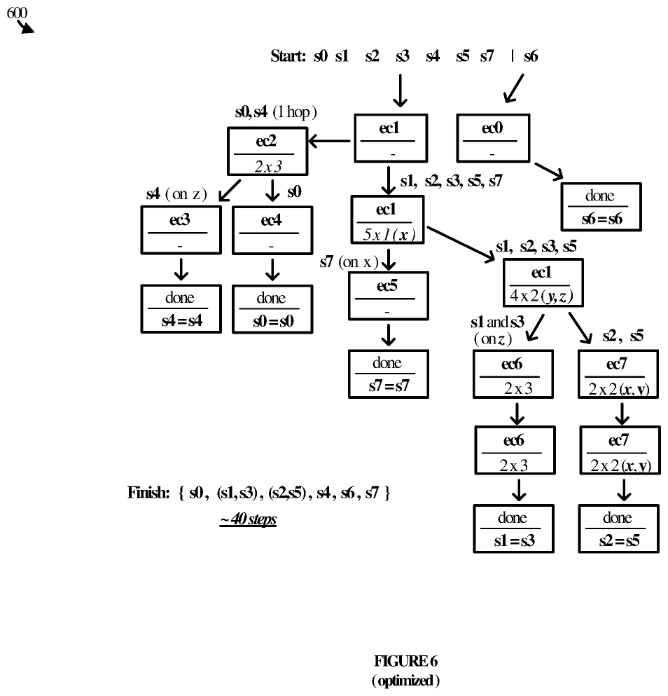

FIGS. 3-6 illustrate an exemplary DFA in an implementation, and the application of two different minimization processes to highlight the advantages of the optimizations disclosed herein. FIG. 3 illustrates the DFA in detail, while FIG. 4 illustrates a non-optimized minimization process. FIG. 5 illustrates the resulting minimized graph, while FIG. 6 illustrates an optimization minimization process for achieving the same, but in fewer steps.

FIG. 3 illustrates graph 301 having nodes, edges, and transitions therebetween. FIG. 3 also illustrates a state table 311 that represents the transitions in graph 301. Graph 303 is a directed graph and therefore is a deterministic finite automaton. The DFA implemented by graph 303 includes the letters x, y, and z in its alphabet, as well as eight different states (s0-s7). State s1 is the starting state and state s6 is a final (accepting) state.

The nodes in graph 301 represent the states of the DFA, while the edges leading from one node to another (or looping back onto the same state) represent the transitions on a given label. State table 311 illustrates the same states and transitions of the DFA but in a tabular format. For example, state s1 transitions to state s2 on x, whereas state s2 remains on state s2 on x. State s3 also transitions to state s2 on x and y, whereas state s2 transitions to s3 on y, and so on. The dash (-) symbol indicates by convention that those states do not have an edge for that label, often implemented internally as an edge to an internal dead-end state.

FIG. 4 illustrates a minimization process 400 that reduces graph 303 without using any of the optimizations disclosed herein. Minimization process 400 begins with states s0-s7. In a first step, minimization process 400 splits states s0-s7 into two equivalence classes: EC-0, which includes all accepting states (s6); and EC-1, which includes the non-accepting states (s0, s1, s2, s3, s4, s5, and s7).

Next, the process iteratively checks whether any ECs contain states where the same label leads to different ECs and splits those states into new ECs, until no further partitions can be made. In this example, the process performs a pass through all of the states in EC-1 with respect to all of the labels in the alphabet to determine whether EC-1 can be split into further equivalence classes. The split is based on whether, for the same label, those states have edges leading to states belonging to distinct equivalence classes. That would prove they lead to an observably different result for that label—those destination states are in distinct equivalence classes because earlier processing has already proven they match different input/lead to a different result, so they in turn also match different input.

The determination is made based on whether a given state behaves the same way on a given label as another state in the equivalence class being evaluated. As just one example, the determination is made based on the equivalence class to which a state transitions on a given label. States that transition to the same equivalence class may behave the same for further input, based on information so far, whereas states that transition to a different equivalence class have already been proven to behave differently for further input. The first group of states can therefore be split into a new equivalence class, while the second group can be split into another equivalence class. It may be appreciated that an equivalence class can be split into more than two new equivalence classes and that the splitting scenarios disclosed herein are merely exemplary.

The basis that governs whether an equivalence class can be split may be set before analyzing the states in an equivalence class or may be discovered as the states in a class are examined. In some cases, the behavior of the first state to be examined sets the criteria against which the other states in the equivalence class are examined. In other cases, the behavior of all of the states in a class is determined and then compared to determine which states behave the same or differently with respect to each other and thus how the states could be potentially grouped and split out into new equivalence classes.

Here, all of the states in EC-1 transition on x to states that are also in EC-1, meaning that the states all behave the same on x. Next, the process examines the states on y to determine if their behaviors differ and thus can be split out. Indeed: s1, s2, s3, s5, and s7 all transition to states in EC-1, whereas s0 and s4 transition to s6, which is not in EC-1. The first group of states (s1, s2, s3, s5, and s7) therefore behave differently than the second group (s0 and s4) as s6 is in EC-0 and is not in EC-1. Two new equivalence classes are thus created: EC-2 and EC-3. State s0 and s4 are split-out from the other states in EC-1 and are moved into a new equivalence class EC-2, while the remaining states in EC-1 are moved into EC-3. Note that twenty-one steps or calculations were performed to arrive at the conclusion that s0 and s4 can be split-out from EC-1 because the equivalence class included seven states and the complete alphabet includes three labels.

Next, minimization process 400 proceeds to analyze the new equivalence classes, beginning with EC-2. EC-2 is analyzed to determine whether s0 and s4 behave differently with respect to each other on any of the labels. Indeed, s0 and s4 behave differently with respect to each other on z by virtue of their transitioning to states in different equivalence classes: s0->s7 (EC-3) on z, and s4->s6 (EC-0) on z. EC-2 is therefore split into EC-4 and EC-5, each of which include only a single state, s0 and s4 respectively. Note that the analysis performed to split EC-2 required six steps (2×3), while the analysis of EC-4 and EC-5 will require three steps for each (1×3). As EC-4 and EC-5 each contain a single state, they cannot be split, but minimization process 400 does not conclude so until performing a final pass through all remaining equivalence classes to determine whether they can be split any further.

Minimization process 400 next returns to EC-3, which was split-out from EC-1 above. The analysis of EC-3 takes fifteen steps (5×3) and determines to split-out s7 from EC-3 by virtue of its behaving differently on x relative to the other labels in EC-3. State s7 behaves differently on x by transitioning to s4 in EC-2, whereas all the others transition to s2 in EC-3. EC-3 is thus split into EC-6 and EC-7. EC-6, which includes only s7, is analyzed for all labels and naturally cannot split. Upon performing the final pass through all of the remaining equivalence classes, the process determines conclusively that EC-6 cannot be split any further and is done.

EC-7 is then analyzed for states s1, s2, s3, and s5 and on all labels. Minimization process 400 determines to split EC-7 into EC-8 and EC-9 by virtue of s1 and s3 behaving differently on z than s2 and s5. That is, s1 and s3 transition on z to s0, which is in EC-2, whereas s2 and s5 transition to dead states on z. Thus, s1 and s3 behave differently on y by virtue of their transitioning to a state (s4) in an equivalence class (EC-2) that differs relative to the equivalence class (EC-null) of the dead state to which s2 and s5 transition on z. EC-7 can therefore be split into EC-8 and EC-9 on y.

Upon completing EC-7, minimization process 400 proceeds to analyze EC-8 and EC-9. With respect to EC-8, six steps (2×3) are needed to determine that the class cannot be split because all of its states behave the same, and the final pass-through EC-8 confirms that this is so. Similarly, the process determines that EC-9 cannot be split because all of its states behave the same and the final pass concludes that the process is done. S1 and s3 are therefore determined to be equivalent to each other, and s2 and s5 are determined to be equivalent.

It may be appreciated therefore that approximately ninety-three steps (93) were required to minimize the graph from eight states to six states. The final graph includes the following states, with equivalent states grouped parenthetically: {s0, (s1, s3), (s2,s5), s4, s6, s7}.

The results provided by minimization process 400 can be used to minimize graph 301 as illustrated in FIG. 5. Graph 501 represents the minimized version of graph 301, while state table 511 represents the corresponding state table for the same. The total number of states has been reduced to just six from eight, while the number of distinct edges has also shrunk. The minimized graph is smaller and therefore faster to traverse, compile, or otherwise process in the context of searching for sequences to block in incoming strings.

For example, states s1 and s3 are now combined into a single state as their behavior rendered them redundant relative to each other. Similarly, states s2 and s5 are combined into a single state as their behavior rendered them redundant. Combining s1 and s3 into a single state also reduced the number of edges in the graph, as did the combination of s2 and s5 into a single state.

FIG. 6 illustrates a minimization process 600 that reduces graph 303 using all of the optimizations disclosed herein. The states are initially split into EC-0 and EC-1, with EC-0 holding all accepting states (s6) and EC-1 holding all the others. In a first step, the states in EC-1 are filtered based on their distance to an accepting state. The filter in this example separates any states that are one hop away from an accepting state (EC-2=s0 and s4) from any states that are more than one hop away, which remain in EC-1 (s1, s2, s3, s5, and s7), although the filter could be set to group the states at any level of granularity that is desired. For example, the states could be grouped into three subsets: one hop, two hops, three hops, and so on. It may also be appreciated that the very first step of separating the states into accepting and non-accepting states is itself a distance filter since accepting states have a distance of zero, whereas non-accepting states have a non-zero distance.

Proceeding with the exemplary arrangement, the next step considers whether any of the equivalence classes have less than two states. Here, EC-0 satisfies this condition as its only state is s6. EC-0 is therefore dispatched to the “done pile” accordingly and no further steps are performed to concluded that it cannot be split, thereby saving time and resources.

EC-2 is then analyzed to determine whether it can be split on any labels, which takes approximately six steps. Indeed, s4 and s0 behave differently relative to each other on z and, as such, cause EC-2 to split into EC-3 and EC-4. The behavior difference on z is that s0 transitions to s7 in EC-1, whereas s4 transitions to s6 in EC-0. In other words, s0 and s4 transition on z to states in different equivalence classes and can therefore be split. Alternatively, EC-2 could be “split in place” by leaving s0 or s4 in EC-2 and only splitting out one of them into a new state EC-J. Doing so would further reduce the number of steps involve in minimizing the graph. (It may be understood that if this alternative approach were taken, then the EC numbering in the remainder of the exemplary scenario would change slightly, but the substance of the example would remain the same.)

Then, the aforementioned minimization related to classes with less than two states causes the process to conclude that EC-3 and EC-4 can be split no further. This avoids the steps incurred by conducting a final pass through a state that it is logical to consider done. Alternatively, it may be appreciated that s0 and s4 could remain in-place in EC-2 while the other states (s1, s2, s3, s5, and s7) are split-out into a new class EC-3.

The minimization process 600 then returns to EC-1 to determine whether it can be split on any labels. Indeed, EC-1 splits out s7 on x into EC-5 because s7 behaves differently than the other states on x. Namely, s7 transitions to a state (s4) in an equivalence class (EC-2) that differs relative to the equivalence class (EC-1) of the state (s2) to which the remaining states transition on x. However, EC-1 is “split in place” in that the minimization process continues to analyze the remaining states for the remaining labels y and z. That is, states s1, s2, s3, and s5 are analyzed for y and z, which requires four steps, representing an improvement over re-analyzing all four states for all three labels.

Here, the minimization process concludes to split EC-1 on z for s1 and s3, which behave differently than s2 and s5 by transitioning to states in different equivalence classes. States s1 and s3 behave differently on z by virtue of their transitioning to a state (s0) in an equivalence class (EC-2) that differs relative to the equivalence class (EC-null) of the dead state to which s2 and s5 transition on z. States s1 and s3 are therefore split out into EC-6, while s2 and s5 are split out into EC-7. Alternatively, EC-1 could again be “split in place” by leaving s1 and s3 in EC-1 (or s2 and s5) and splitting out the other pair into a new state EC-K. Doing so would further reduce the number of steps involve in minimizing the graph. (It may be understood that if this alternative approach were taken, then the EC numbering in the remainder of the exemplary scenario would change slightly, but the substance of the example would remain the same.)

EC-6 is then analyzed to determine if s1 and s3 can be split. However, s1 and s3 share the same behavior for all labels and therefore cannot be split. The final pass through all of the equivalence classes confirms as much and EC-6 is placed on the “done” pile.

EC-7 is also analyzed to determine if s2 and s5 can be split. However, s2 and s5 are only analyzed with respect to x and y, since x and y are the only labels on which s2 and s5 transition. That is, s2 and s5 are not defined for z and thus need not be analyzed for z. Minimization process 600 therefore concludes that EC-7 cannot be split, which is confirmed when the final pass through all of the classes is performed.

EC-5, which was created from EC-1 when s7 split on x, remains to be processed. Since EC-5 contains only a single state—s7—it can be concluded that it cannot be split. Monitoring process 600 can therefore move EC-5 to the done pile without any further steps.

Minimization process 600 produces the same minimized results as minimization process 400, but approximately forty (40) steps as a result of the optimizations 211-214 employed, compared to the approximately ninety-three steps taken by minimization process 400. The same or better results would be expected with much larger and more complex than the graph 301 and would lead to a reduced time to minimization and therefor compilation into a graph or other such data structure that can be deployed at run-time.

FIG. 7 illustrates computing system 701 that is representative of any system or collection of systems in which the various processes, programs, services, and scenarios disclosed herein may be implemented. Examples of computing system 701 include, but are not limited to, desktop and laptop computers, server computers, web servers, cloud computing platforms, and data center equipment, as well as any other type of physical or virtual server machine, container, and any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements minimization process 706, which is representative of the minimization processes discussed with respect to the preceding Figures. When executed by processing system 702 to provide direct server reply, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including minimization process 706) may be implemented in program instructions and among other functions may, when executed by processing system 702, direct processing system 702 to operate as described with respect to the various operational scenarios, sequences, and processes illustrated herein. For example, software 705 may include program instructions for implementing a minimization process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to perform graph minimizations in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method comprising:
identifying regular expressions indicative of data patterns to enforce against malicious traffic in a firewall;
generating a graph based at least in part on the regular expressions, wherein the graph comprises states, labels, and transitions between certain ones of the states on certain ones of the labels;
performing a minimization of the graph to produce a minimized graph, wherein performing the minimization includes grouping the states into equivalence classes based on a distance of each state to an accepting state; and
employing the minimized graph in the firewall to protect against instances of the data patterns in the data traffic.

2. The method of claim 1 wherein performing the minimization of the graph to produce the minimized graph further comprises:
determining whether a given equivalence class has less than two states;
determining to attempt to split the given equivalence class when the given equivalence class has more than two states; and
determining to refrain from attempting to split the given equivalence class when the given equivalence class has less than two states.

3. The method of claim 2 wherein performing the minimization of the graph to produce the minimized graph further comprises attempting to split the given equivalence class into multiple equivalence classes by at least, for each label of the set of labels:
evaluating a subset of the states in the given equivalence class to identify qualifying states that behave the same as each other on the label and differently relative to all others on the label; and
splitting out the qualifying states into at least one new equivalence class; and
continuing to evaluate the others of the subset of the states on remaining ones of the set of labels after splitting out the qualifying states on the label.

4. The method of claim 2 wherein performing the minimization of the graph to produce the minimized graph further comprises attempting to split the given equivalence class into multiple equivalence classes by at least:
identifying a subset of the labels on which a subset of the states in the given equivalence class transition, wherein the subset of the labels comprises only those of the labels on which those of the states in the given equivalence class transition;
for each label of only the subset of the labels, evaluating the subset of the states in the given equivalence class to identify qualifying states that behave the same as each other on the label and differently relative to all others on the label; and
splitting out the qualifying states into at least one new equivalence class.

5. The method of claim 1 wherein performing the minimization of the graph to produce the minimized graph further comprises attempting to split a given equivalence class into multiple equivalence classes by at least, for each label of the set of labels:
evaluating a subset of the states in the given equivalence class to identify qualifying states that behave the same as each other on the label and differently relative to all others; and
splitting out the qualifying states into at least one new equivalence class; and
continuing to evaluate the others of the subset of the states on remaining ones of the set of labels after splitting out the qualifying states on the label.

6. The method of claim 1 wherein performing the minimization of the graph to produce the minimized graph further comprises attempting to split a given equivalence class into multiple equivalence classes by at least:
identifying a subset of the labels on which a subset of the states in the given equivalence class transition, wherein the subset of the labels comprises only those of the labels on which those of the states in the given equivalence class transition;
for each label of only the subset of the labels, evaluating the subset of the states in the given equivalence class to identify qualifying states that behave the same; and
splitting out the qualifying states into at least one new equivalence class.

7. The method of claim 1 wherein the regular expressions comprise character strings, the labels comprise a single label for each individual character occurring in the character strings, and the graph comprises a deterministic finite automaton that filters out the malicious traffic as data traffic passes through the firewall.

8. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
identify regular expressions indicative of data patterns to enforce against malicious traffic in a firewall;
generate a graph based at least in part on the regular expressions, wherein the graph comprises states, labels, and transitions between certain ones of the states on certain ones of the labels;
when performing a minimization of the graph to produce a minimized graph, group the states into equivalence classes based on a distance of each state to an accepting state; and
employ the minimized graph in the firewall to protect against instances of the data patterns in the data traffic.

9. The computing apparatus of claim 8 wherein, to perform the minimization of the graph to produce the minimized graph, the program instructions further direct the computing apparatus to:
determine whether a given equivalence class has less than two states;
determine to attempt to split the given equivalence class when the given equivalence class has more than two states; and
determine to refrain from attempting to split the given equivalence class when the given equivalence class has less than two states.

10. The computing apparatus of claim 9 wherein:
to perform the minimization of the graph to produce the minimized graph, the program instructions further direct the computing apparatus to attempt to split the given equivalence class into multiple equivalence classes; and
to attempt to split the given equivalence class into the multiple equivalence classes, the program instructions direct the computing apparatus to, for each label of the set of labels:
evaluate a subset of the states in the given equivalence class to identify qualifying states that behave the same as each other on the label and differently relative to all others on the label;
split out the qualifying states into at least one new equivalence class; and
continue to evaluate the others of the subset of the states on remaining ones of the set of labels after splitting out the qualifying states on the label.

11. The computing apparatus of claim 10 wherein to perform the minimization of the graph to produce the minimized graph, the program instructions further direct the computing apparatus to:
identify a subset of the labels on which a subset of the states in the given equivalence class transition, wherein the subset of the labels comprises only those of the labels on which those of the states in the given equivalence class transition;
for each label of only the subset of the labels, evaluate the subset of the states in the given equivalence class to identify qualifying states that behave the same as each other on the label and differently relative to all others on the label; and
split out the qualifying states into at least one new equivalence class.

12. The computing apparatus of claim 10 wherein:
to perform the minimization of the graph to produce the minimized graph, the program instructions further direct the computing apparatus to attempt to split a given equivalence class into multiple equivalence classes;
to attempt to split the given equivalence class into the multiple equivalence classes, the program instructions direct the computing apparatus to, for each label of the set of labels:
evaluate a subset of the states in the given equivalence class to identify qualifying states that behave the same as each other on the label and differently relative to all others on the label;
split out the qualifying states into at least one new equivalence class; and
continue to evaluate the others of the subset of the states on remaining ones of the set of labels after splitting out the qualifying states on the label.

13. The computing apparatus of claim 8 wherein:
to perform the minimization of the graph to produce the minimized graph, the program instructions further direct the computing apparatus to split a given equivalence class into multiple equivalence classes; and
to attempt to split the given equivalence class into the multiple equivalence classes, the program instructions direct the computing apparatus to:
identify a subset of the labels on which a subset of the states in the given equivalence class transition, wherein the subset of the labels comprises only those of the labels on which those of the states in the given equivalence class transition; and
for each label of only the subset of the labels: evaluate the subset of the states in the given equivalence class to identify qualifying states that behave the same as each other on the label and differently relative to all others on the label; and
split out the qualifying states into at least one new equivalence class.

14. The computing apparatus of claim 8 wherein the regular expressions comprise character strings, the labels comprise a single label for each individual character occurring in the character strings.

15. The computing apparatus of claim 8 wherein the graph comprises a deterministic finite automaton that filters out the malicious traffic as data traffic passes through the firewall.

16. A method comprising:
identifying regular expressions indicative of data patterns to enforce against malicious traffic in a firewall;
generating a graph based at least in part on the regular expressions, wherein the graph comprises states, labels, and transitions between certain ones of the states on certain ones of the labels;
grouping the states into equivalence classes;
performing a minimization of the graph to produce a minimized graph, including evaluating one or more of the equivalence classes to determine whether to attempt to split a given equivalence class into multiple equivalence classes based on a number of states in the given equivalence class.

17. The method of claim 17 wherein performing the minimization of the graph to produce the minimized graph further comprises:
determining to attempt to split the given equivalence class when the given equivalence class has two or more states; and
determining to refrain from splitting the given equivalence class when the given equivalence class has less than two states.

18. The method of claim 16 further comprising splitting at least one of the equivalence classes into two or more other equivalence classes based at least on a subset of the labels, wherein the subset of the labels includes only those of the labels that occur in an equivalence class being split.

19. The method of claim 18 wherein splitting the at least one of the equivalence classes into the two or more other equivalence classes comprises splitting the equivalence class in-place, at an end of a pass through the equivalence class on a one of the labels in the subset of the labels, before proceeding to a next pass through the equivalence class on a next one of the labels in the subset of the labels.

20. The method of claim 16 wherein grouping the states into the equivalence classes comprises grouping the states based on a distance of each of the states to a final state.
